(19) United States
(12) Patent Application Publication
(10) Pub. No.: US 2005/0197947 A1
(43) Pub. Date: Sep. 8, 2005

(54) Method of converting delinquent assets to revenue or cash flow

(76) Inventor: Harry J. Tyson, Manhasset, NY (US)

Correspondence Address: GREENBERG-TRAURIG, 1750 TYSONS BOULEVARD, 12TH FLOOR, MCLEAN, VA, 22102, US

(21) Appl. No.: 11/051,465

(22) Filed: Feb. 7, 2005

Related U.S. Application Data
(60) Provisional application No. 60/548,221, filed on Mar. 1, 2004.

(51) Int. Cl. G06F 17/60

(52) U.S. Cl. 705/36

(57) ABSTRACT

A method for generating revenue and cash by agreeing to sell delinquent assets in a dynamic portfolio of delinquent assets on a periodic basis. An agreement is made to periodically sell a current set of delinquent assets to an entity such as a local development corporation. During each of several periods/intervals of the agreement, historical data reflecting a current portfolio of delinquent assets is used to determine a historical collection model (e.g., a determination of the collection period for the set of delinquent assets) and the model is used to determine a projection of collections for the current set of delinquent assets based upon the historical collection model, the projection preferably including principle, along with interest and penalties due as a result of the delinquency of set of delinquent assets. A present value of the projection of collections is calculated based upon a market borrowing index and a market investment index. A delinquent asset purchase price for the set of delinquent assets is determined. Finally, at each period/interval of the agreement, the set of delinquent assets is sold to the entity for the delinquent asset purchase price, thereby providing revenue from the dynamic portfolio of delinquent assets. At least one bond is preferably issued, the proceeds of which are used to pay the delinquent asset purchase price at each sale. Transactional fees are paid directly from the proceeds of the sale of the set of delinquent assets before payment is made to a seller of the delinquent assets, from other available funds, or from the first funds collected from the assets purchased. Revenue derived from the sale of the set of delinquent assets is transferred from entity/buyer to a stabilization fund, which is used for the payment of debt service on the bond(s). The stabilization fund can be used to purchase newly created delinquent assets when all outstanding bonds have been redeemed, and residual stabilization funds can be used, e.g., for the benefit of a municipality's residents after all program bonds are retired and the program's final liens are purchased.

### REFERENCE TO RELATED APPLICATIONS

This application claims priority to U.S. Provisional Patent Application No. 60/548,221 filed Mar. 1, 2004, which is herein incorporated by reference in its entirety.

### FIELD OF THE INVENTION

This invention relates in general to delinquent receivables, and in particular to a method for a municipality to sell delinquent tax assets for revenue and cash flow.

### BACKGROUND

Most governed societies have taxes. Likewise, very few municipal entities collect all taxes levied on a current basis. As a result, almost every municipality has delinquent tax receivables. Similar to municipalities, corporations and individuals have delinquent receivables. Delinquent receivables may be in the form of delinquent taxes, delinquent credit card receivables, delinquent car loans, etc. A municipality's delinquent taxes and all other delinquent assets are, together, referred to herein as “delinquent assets.”

Delinquent assets may be sold to generate revenue. If delinquent assets are not sold, the entity that is owed the delinquent assets, e.g., the municipality receives revenue under Generally Accepted Accounting Principals (“GAAP”) only when the party that owes the delinquent assets makes a ready money payment of principal, interest, and penalty. The existence of delinquent assets and the lack of control over the timing of collection of delinquent assets create a budgetary problem for these entities.

Municipal delinquent taxes are converted into tax liens or “liens” after some period of delinquency. Municipalities have different methods for handling tax liens. Municipalities previously had three options regarding generating revenue and cash flow from tax liens. First, the municipality can retain its tax liens and generate both revenue and cash flow when tax liens are collected.

Second, the municipality can retain its tax liens and issue delinquent tax anticipation notes (“DTANs”) at least once annually to generate cash flow prior to the receipt of revenue, which is generated when tax liens are collected. Under this option, revenue and cash flow are different. Revenue is still generated when tax liens are collected; cash flow is generated from the proceeds of the DTANs. Therefore, an analysis between the present invention and the DTAN program includes a comparison of the present invention with existing revenue (tax lien collection) and cash flow (DTAN proceeds).

Third, the municipality can sell its tax liens under an existing alternate (conventional) bulk tax lien program, which generates revenue and cash flow upon sale. This option requires a comparison of the present invention to a conventional tax lien program. Since there are several conventional tax lien programs available, specific details of the conventional program are needed to develop a comparison. Regardless of the conventional tax lien program utilized, the revenue in the first year of any conventional tax lien program will likely be lower than the present invention due to the fact that the security requirements of conventional programs generate a low initial purchase price as compared to the present invention.

In the second conventional system, a municipality may issue DTANs to provide cash flow. Revenue and cash flow are both important factors in the analysis of this system. Revenue analysis is important because the municipality uses revenue to create its annual budget. Cash flow analysis is equally important since it is cash flow that is actually used to pay expenses. The municipality issues DTANs to generate cash flow annually. When revenue is generated from the collection of tax liens, it is used, all or in part, to pay principal and interest on the DTANs.

Due to security risks, existing conventional bulk lien sales pay substantially below the present value of the liens purchased. All existing bulk lien sale purchase programs are based solely on the value of the current liens being purchased and, in some cases, re-pledged previous lien purchases. As a result, there can be no assurance that liens being purchased will have the same collection rate as historic collections. In other words, the fact that previously purchased liens average, for example, a 90% collection rate does not assure that currently purchased liens will average the same collection rate.

As a result of this security risk, conventional bulk lien purchase programs pay about 70% of the estimated present value of the liens purchased. The 70% purchase price gives the purchaser about 145% projected asset coverage. Projected asset coverage is calculated by the sum of the estimated present value of tax liens purchased and any other pledged assets divided by the purchase price. Even with this coverage, bulk lien sales are not automatically considered to be 100% AAA grade investments. In order to sell debt at the lowest borrowing cost, a buyer often divides the liens into several security levels, i.e., investment ratings. For example, a first lien may be applied to about 70% of the debt issued to obtain a AAA rating; a second lien of 15% may receive a AA rating; and a third lien for the remaining 15% may receive an A rating. In effect, the first lien has about 200% projected asset coverage, the second lien has about 170% projected asset coverage, and the third lien has about 145% projected asset coverage. If the purchaser sold all bonds to complete the purchase with one rating, the entire issue would likely receive an A rating. By dividing the security into three levels, the debt can be sold at a lower overall borrowing cost.

### SUMMARY OF THE INVENTION

The present invention solves the issues of revenue and cash flow of the conventional DTAN program. In the present invention revenue and cash flow are generated simultaneously. In fact, the present invention generates about the same cash flow as the DTANs over the life of the program and significantly more in the first year of the program. Further, the program of the present invention does not result in a significant increase in debt service as compared to DTANs over the term of the program.

The present invention generates significant additional revenue from an initial purchase. Each year, in most cases, the program generates revenue in excess of 100% of the principal amount of delinquent taxes, assuming an average 90% collection rate.

The present invention is similar to the DTAN program in several ways. First, the present invention does not impact the municipality's tax lien collection method and does not require State legislation. Second, the present invention will most likely be sold either in whole or in part with a one year tax exempt rate similar to DTANs. Finally, the present invention will likely carry a high credit rating.

Several important characteristics of the present invention distinguish it from DTANs. First, the DTANs produce cash flow, but not revenue, upon sale. The present invention produces both revenue and cash flow upon sale. Second, the principal amount of DTANs permitted to be issued is restricted by individual state law. The present invention allows for the sale of all outstanding tax liens. Finally, in future years, only the present invention will ensure revenues in excess of the tax levy for each year. Thus, the present invention removes any risk of higher taxes resulting from tax delinquencies being placed on those taxpayers who pay taxes on time.

Likewise, there are several differences between the present invention and alternative tax lien programs. First, the present invention may generate a minimum of 95% of the present value of liens sold as initial revenue. The conventional tax lien programs only generate about 70%. This results in a 25% increase in initial “efficiency.” Second, under the present invention, the residual is available for use at the end, or termination, of the program. Under conventional tax lien programs, the residual may revert back, similar to the present invention, but its timing is unknown. Third, under the present invention, the revenue flow is definite and annually exceeds the tax levy. Fourth, the present invention creates or acquires in whole or in part highly rated tax-exempt securities. Conventional tax lien programs have medium grade credits or sliding credit ratings. Additionally, the conventional tax lien programs have been issued as taxable securities. Fifth, the present invention allows a municipality to maintain control over the collection process. (Control over the collection process, in many cases, is the greatest deterrent to municipalities utilizing conventional bulk lien sale programs. Loss of control can result in delinquent taxpayers not having the opportunity to plead their case to their elected officials.) Conventional tax lien programs require an independent collection process. Independent collection agents typically charge very significant fees that are not paid under the present invention. Naturally, under the present invention, the municipality continues to incur its own collection costs. Finally, the present invention does not require a detailed valuation of the tax liens. Conventional tax lien programs entail a thorough accounting of liens to be sold, which is a significant cost inherent in the programs.

The program of the present invention eliminates the risks related to the timing of delinquent tax collections and assists the municipality in more accurately determining property tax revenue for future budgets. One significant benefit of the program of the present invention always remains intact: the program enables the municipality to collect taxes levied in the year of their levy at a minimum price equal to 95% of the present value of the tax liens created.

Other advantages of the present invention are readily apparent. First, in an “ideal” economic environment, all taxpayers would pay their taxes on time and the municipality would not make loans to delinquent taxpayers. The present invention enables the municipality to mimic the “ideal” economic environment and collect all delinquent taxes in the year of their levy. In addition, the program also permits the municipality to retain the value of the significant interest and penalty charges on such delinquencies. Second, in each future year, the municipality, through the program, will be assured that tax collections will exceed the property tax levy. Finally, the municipality's existing policy of holding liens is neither in the municipality's interest nor its taxpayers' interest. Holding liens delays the receipt of tax collections, i.e., revenue, due in the current fiscal year. As a result, in times of economic stress, i.e., greater tax delinquencies, this policy requires property owners who pay their taxes on time to make up the revenue shortfall of delinquent taxpayers.

Finally, and of significant importance, the program eliminates the financial liability created by tax delinquencies in times of economic stress.

In its preferred embodiment, the invention provides a method for a municipality to generate revenue and cash from tax liens by agreeing to sell delinquent assets in a dynamic portfolio of delinquent assets to a local development corporation (or any other legal entity required to implement a true sale under GAAP) on a periodic basis. An agreement is made to periodically sell a current set of delinquent assets to the buyer over a time period. During at least two of the several periods/intervals of the agreement, historical data reflecting a current portfolio of delinquent assets is used to determine a current historical collection model. The model is then used to determine a projection of collections for the current set of delinquent assets based upon the historical collection model. The projection of collections for the set of delinquent assets preferably includes principle, along with interest and penalties due as a result of the delinquency of set of delinquent assets. A present value of the projection of collections is calculated, the present value being based upon a market borrowing index and/or a market investment index. A delinquent asset purchase price for the set of delinquent assets is determined, and is preferably less than or equal to the present value of the set of delinquent assets sold. Finally, for each period/interval of the agreement, the set of delinquent assets is sold to the buyer for the delinquent asset purchase price, thereby providing revenue from the dynamic portfolio of delinquent assets. At least one bond is preferably issued, the proceeds of which are used to pay the delinquent asset purchase price at each sale. The transactional fees may be paid directly from the proceeds of the sale of the set of delinquent assets before payment is made to a seller of the delinquent assets, from some other source of funds, or from the first collection of liens after the sale. Revenue derived from the sale of the set of delinquent assets is transferred from a buyer to a stabilization fund, which is used for the payment of debt service on the bond(s). The stabilization fund is used to purchase newly created delinquent assets when all outstanding bonds have been redeemed, and residual stabilization funds are used for the benefit of the municipality's residents after all program bonds are retired and the program's final tax liens are purchased.

In other aspects, the invention provides a method for providing revenue from delinquent assets which includes the steps of selecting a period for buying a plurality of delinquent assets; determining a payment price for the plurality of delinquent assets at selected intervals of the period; determining a historical collection cycle; estimating delinquent assets to be collected during the selected interval based on a most recent completed historical collection cycle; making an initial payment for delinquent assets, wherein the initial payment comprises outstanding delinquent assets and estimated delinquent assets to be collected; making at least one interval payment, wherein the payment is made at the selected intervals and comprises the estimated delinquent assets to be collected; wherein payments are made until the selected interval that occurs at the period length minus the length of the collection cycle; and issuing or acquiring bonds, wherein proceeds are used to purchase delinquent assets. The period is preferably at least two years, up to a maximum of forty years or more; the collection cycle could be as short as two years or as long as ten years, with a 5-7 year period being a typical collection cycle for a municipality. The contract may be cancelled and renegotiated at a different purchase price. Alternatively, amortization of the bonds may be delayed by remarketing the bonds at a predetermined interval. The seller is a municipality. The buyer is a corporation.

It is to be understood that both the foregoing general description and the following detailed description are exemplary and explanatory and are intended to provide further explanation of the invention.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of at least one embodiment of the invention.

In the drawings:

FIG. 1 is a diagram of the program according to an embodiment of the present invention.

FIGS. 2(a)-(d) are tables of purchased liens according to an embodiment of the present invention.

### DETAILED DESCRIPTION OF THE PREFERRED EMBODIMENTS

Reference will now be made in detail to the preferred embodiments of the present invention, examples of which are illustrated in the accompanying drawings.

The delinquent tax and asset bond program (“DTAB program” or “program”) of the present invention is a long term financial program that periodically converts delinquent assets into revenue. Delinquent assets are purchased shortly after their creation at a higher purchase price and with less complexity than all other conventional delinquent tax lien purchase programs. The higher purchase price results from a substantially long term purchase contract required by the program as well as the formula of the program.

A seller may be a single municipality or several municipalities acting collectively to sell their delinquent assets to a buyer according to the terms in a purchase contract. The buyer may be (1) a local development corporation, (2) a corporation created or expanded to purchase delinquent assets, (3) a trust, or (4) any other legal entity required to implement a true sale under GAAP. The program, in essence, is the same for all types of entities with delinquent assets. However, a corporation may, with some limitations, issue (and/or acquire) tax-exempt bonds for the purchase of municipal delinquent assets. The present invention is exemplified with a municipal entity to illustrate the impact of the program on revenue and cash flow.

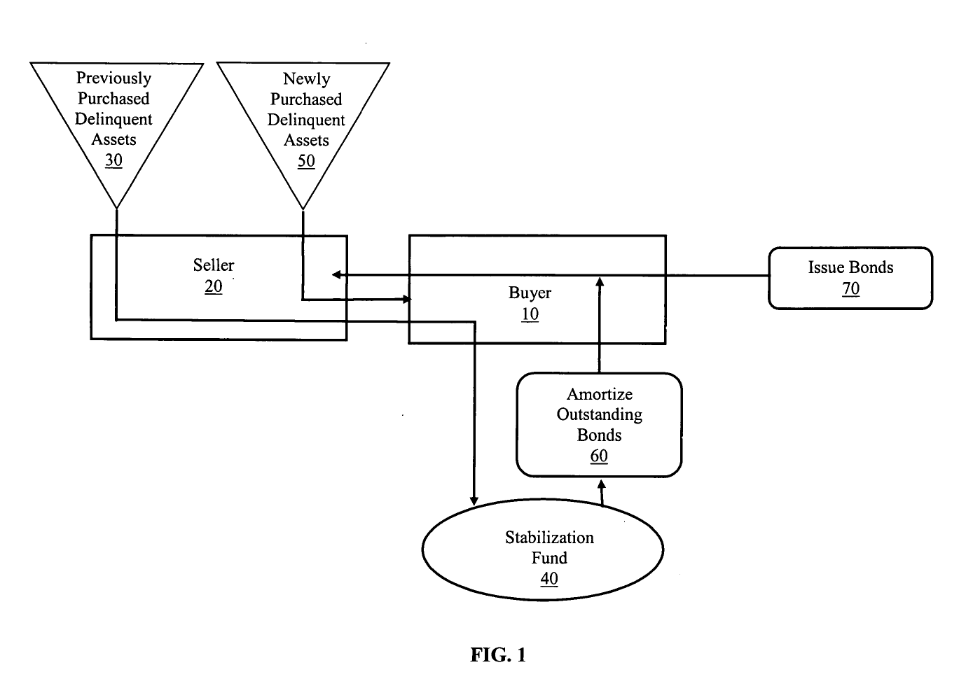

The periodic purchases and flow of funds under the present invention are shown in FIG. 1 and the details of which are explained in further detail herein. In this embodiment, a buyer 10 is a local development corporation (or any other legal entity required to implement a true sale under GAAP) and a seller 20 is a municipality. The buyer 10 enters into a purchase contract with the municipality 20 to purchase outstanding and future tax liens from the municipality 20. The buyer's assets include principal, interest, and penalties on all purchased tax liens. The buyer 10 issues periodic bonds 70 and uses the proceeds to purchase future tax liens. The buyer's assets as well as the purchase contract secure the bonds. As property owners pay their tax liens to the municipality 20, the municipality 20 transfers the payments to the buyer 10. Revenue from the previously purchased delinquent assets 30 is transferred from the buyer 10 to a stabilization fund 40 for the payment of debt service on the bonds. Stabilization funds 40 are available to purchase newly created delinquent assets 50 when all outstanding bonds are redeemed 60. The stabilization fund 40 gradually builds up from the asset coverage and becomes a source of funds to reduce and eventually eliminate the need to issue bonds to purchase tax liens in later years. At the end of the program, after all program bonds are retired and the program's final tax liens are purchased, the remaining collections, i.e., residual, owned by the buyer may be used for the benefit of the municipality's residents. Under an alternative amortization program, revenue may be used to purchase newly created liens before being used to retire outstanding bonds.

The program is an extremely cost-effective method to reduce pressure on the municipality's budget and at the same time provide improved collections in the future. Also, since annual tax collections under the program always exceed the tax levy, the municipality can reasonably project tax collections. This will assist the municipality in budgeting.

Delinquent assets are purchased in bulk, i.e., all of the delinquent tax liens are purchased by a single buyer as opposed to multiple individual buyers. Revenue is created for the seller, e.g., municipality, at the time ownership is transferred. If the delinquent tax liens are not sold, the municipality must account for the delinquent revenue through some other mechanism or wait for the debt to be collected over a number of years. In some instances, delinquent taxes require the municipality to raise taxes on all taxpayers.

Revenue created at the time of sale is just slightly below 100% of the present value of the delinquent assets and such revenue is received by the municipality in the same fiscal year the assets are created. The amount received by the municipality will, in many cases, exceed the amount of the actual delinquent taxes. The sale is made through a long-term contract, e.g., forty year contract, known as a purchase contract. The transaction must be considered a “true sale” under GAAP by both bankruptcy counsel and the seller's accountant in order for sale proceeds to be properly considered revenue.

Even though the amount of delinquent taxes can fluctuate significantly each year depending of the economic climate, the municipality will, over time, have a fairly stable collection rate. The program uses the historical average collection rate to provide the municipality with greater revenue from delinquent taxes in times of economic or fiscal stress, when tax collections are at unusually low levels. Thus, the program enables the municipality to realize more revenue from the sale of its annual tax liens than conventional tax lien programs and minimizes annual fluctuations in property tax revenues. This is accomplished without any change to the municipality's existing property tax collection, accounting, or operating procedures.

Under the program of the present invention, the buyer, according to the purchase contract, agrees to purchase delinquent assets periodically from the seller based on a formula. The purchase contract is an exclusive and binding contract between the corporation and the seller to transfer ownership of all future delinquent assets during the term of such contract on a specified date or dates each year. The formula utilizes a number of variables to determine the purchase price for the delinquent assets. The formula combined with the long-term purchase contract enables the corporation to purchase delinquent assets for a higher purchase price and with less complexity than conventional delinquent asset sale programs.

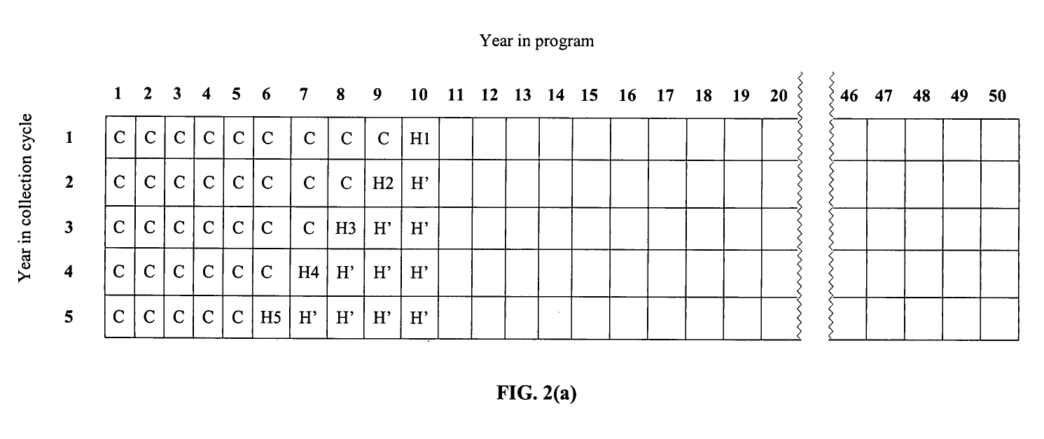

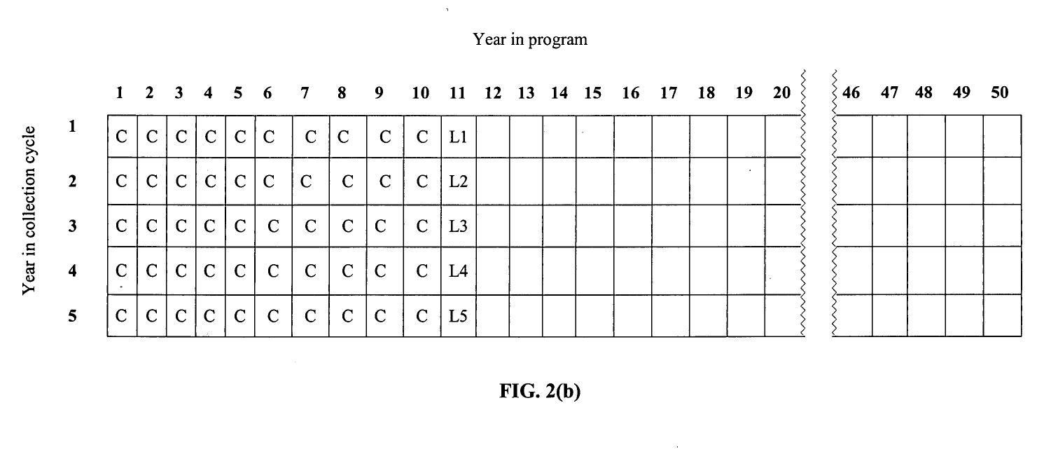

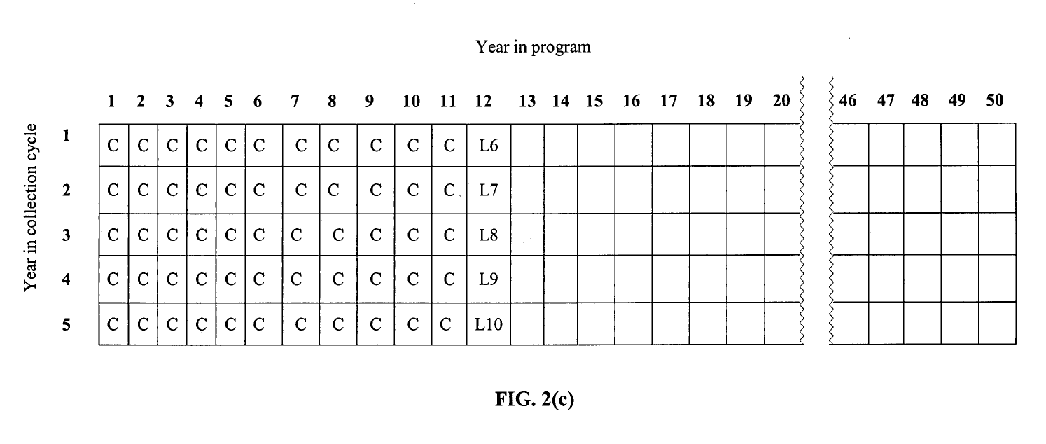

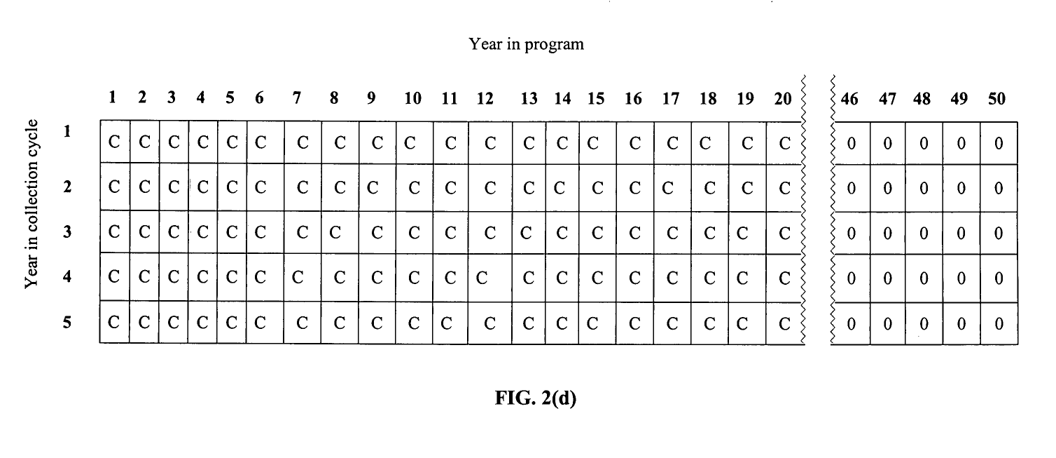

The formula according to one embodiment of the present invention is exemplified in FIGS. 2(a)-(d). In this embodiment, the program term is forty years, shown as years 11-50. The final maturity of the bonds is fixed at forty years from the initial date of issuance and the purchase of tax liens is limited to the first thirty-five years. In one embodiment, all bonds are repaid prior to the final purchase. The forty-year program life has been selected to provide the corporation with a high degree of asset coverage and the municipality with the opportunity to terminate the program without cost. However, the program term may be any length of time from about two years to a substantially infinite length. Preferably, the program term is at least five years as stability of payments increases with the length of the program term.

To determine the purchase price paid on each sale date, the weighted average percent principal collected for all liens created over a predetermined multi year completed collection cycle is computed (five years is used in this analysis). This equals the assumed principal percentage collected. A weighting is also done on the timing of principal collection. In addition, interest and penalty collected associated with principal is also computed. The weighted average principal and interest collected for the respective multi year period is applied to the newly created liens to determine the total amounts to be collected.

In order to calculate the initial purchase price in the first year of the program, ten years of historical data H are used, shown as years 1-10, to accommodate for a five year collection cycle. Preferably, the length of historical data equals the number of years of the collection cycle plus the number of years necessary to provide a reasonable weighted average percent principal collected from the point of view of both rating agencies and investors. Historical data utilized includes the value of liens created by the year as well as the principal amount of collected lien by month. In this embodiment, the created liens are exemplified by collection year for simplicity. However, accounting is typically calculated monthly. The historical data is more accurate if the accounting is performed more often, e.g., daily, and less accurate if done less often, e.g., quarterly. The historical data is used to project the figures of the current year.

Using historical collection rates, the principal and interest of the tax liens are estimated. Using a five year collection cycle, tax liens created in one year will take five years to substantially collect the outstanding liens. Typically, first year collections range between 30% and 55%. Last year collections typically range between 0% and 4%. As a result, liens created in year 3, for example, will be collected in years 4-8. Similarly, during the first year (year 11 in FIG. 2) of the program, liens are being collected from years 6-10. The initial purchase therefore includes the liens owed multiplied by the historical collection rate in addition to the outstanding interest and penalty multiplied by the historical collection rate. In the first year of the program, year 11, liens will be collected from the last five years. Liens already collected by the municipality are represented by C. Outstanding liens H1 are outstanding from year 10 and are in the first year of the collection cycle; outstanding liens H2 are outstanding from year 9 and are in the second year of the collection cycle; outstanding liens H3 are outstanding from year 8 and are in the third year of the collection cycle; outstanding liens H4 are outstanding from year 7 and are in the fourth year of the collection cycle; and outstanding liens H5 are outstanding from year 6 and are in the fifth year of the collection cycle.

The most recent weighted average monthly collection for the five years of completed collections is used to determine the projected collection rate for each annual lien sale. As shown in FIG. 2(a), the most recent five years of completed collections occurred in years 1-5. A discount rate (previously referred to as the market borrowing index and approximately equal to the actual tax exempt borrowing rate) is applied to the lien purchase. In a preferred embodiment, for the purpose of the formula, collections invested until debt service is paid is presumed to be invested at the market investment index. Such investment will impact the present value determined using the formula. The municipality receives a purchase price of a percentage of that amount, plus the residual at the end of the program. In this exemplary embodiment, the purchase price may be approximately 95%.

In year 11, the first year of the program, in the exemplary embodiment, the buyer purchases H1, H2, H3, H4, and H5. These outstanding liens are to be collected over the initial year. For example, in 2004, liens are to be collected from 1999-2003, based on the five year collection cycle.

In the first year, however, the purchase price also includes all the liens estimated to be collected from the previous five years. Thus, as exemplified in FIG. 2(a), the initial purchase includes H1, H2, H3, H4, H5, and H′. H′ represents an unknown amount of collections for outstanding liens. In order to purchase these outstanding amounts, the historical data is used to estimate a collection rate. In this embodiment, the purchase is at the beginning of the year. However, as the year progresses, more accurate values of H′ are known. By the next purchase date, H′ is a known value and has become a collected lien.

Since this exemplary embodiment assumes that the municipality does not currently sell its tax liens, a higher principal amount of tax liens are sold to the corporation in the initial purchase than in subsequent annual purchases. Accordingly, the present invention therefore provides the municipality with substantial additional revenue in the first fiscal year of program implementation.

The second year of the program is exemplified in FIG. 2(b). In the second year (year 12 in FIG. 2), the buyer purchases L1, L2, L3, L4, and L5. These collections represent the estimated collections due based on the historical data of the most recent completed five year collection cycle. The projected principal, interest, and penalty collected is based on the weighted average monthly collection of five years of completed historical collections data. For example, liens purchased on Dec. 1, 2004, are based on collections of liens created Dec. 1, 1995 through Dec. 1, 1999.

The third year of the program is exemplified in FIG. 2(c) and is similar to the second year. In the third year (year 13 in FIG. 2), the buyer purchases L6, L7, L8, L9, and L10, representing the estimated collections due based on the historical data of the most recent completed five year collection cycle. Each yearly purchase in the program continues in a similar fashion until the final purchase date. As the year's progress and the payments begin to stabilize, gradually asset coverage increases. In order to generate revenue under GAAP, the purchase price percent may need to remain constant during the life of the program. However, as years progress and asset coverage increases, the municipality can terminate the initial program and enter into a new contract at a higher purchase price percent (perhaps as much as 100%).

The final purchase date is calculated by the term of the program minus the number of years in the collection cycle. Thus, due to the five year collection cycle, the buyer does not buy any more liens within five years of the end of the program, i.e., after year thirty-five. Instead, the buyer collects the payments due, creating a residual towards the end of the program. In the thirty-sixth year (year 46 in FIG. 2) of the forty year program, no more new liens are purchased by the buyer, as shown in FIG. 2(d).

The formula of the present invention provides maximum annual revenue and enables the program to comply with true sale requirements. Two vital components of the formula are the “market borrowing index” and the “market investment index.” In order to comply with true sale requirements over the life of the program, the purchase price may not be based on the actual interest rate on program bonds or the actual investment rate on program receipts. Instead, an independent market index is required. Therefore, both a borrowing and investment index must be developed based on available market indices that closely tracks actual interest rates paid and collected. The projected investment income on collections is invested to the end of each quarter at the market investment index.

The purchase price equals the present value of the projected principal, interest and penalty collected and projected investment income discounted at the market borrowing index multiplied by the purchase percent. The purchase price exceeds the total delinquent tax levy. For example, in many municipalities, an average of 90% or more of the tax liens created are paid prior to or upon foreclosure. In addition, the interest rate for tax liens typically equals or exceeds 12% per annum, excluding any additional penalty. Historically, the interest rate for one-year tax-exempt bonds has averaged less than 3½%. Accordingly, the annual purchase price under the program will significantly exceed the amount the municipality would have collected if all delinquent taxpayers paid their taxes on time. In other words, under the present invention, current tax collections plus the purchase price from tax lien sales provides the municipality with revenues in excess of the tax levy in each future year.

In order to generate the funds required to purchase delinquent assets, the buyer issues bonds during the early years of the purchase contract. In the intermediate years, the program uses a combination of bonds and accumulated cash from previously purchased assets to purchase delinquent assets. In the later years, accumulated cash and, optionally, a small amount of bonds is used to purchase delinquent assets.

The program of the present invention requires certain sale and loan properties to issue tax-exempt bonds. Tax-exempt bonds are likely to be permitted when the program is used to purchase tax liens, but the program must comply with some restrictions. First, the program must be a sale for federal bankruptcy purposes in order to qualify as a true sale under GAAP. The formula variables utilized by the program are necessary in order to comply with this requirement. Second, in order for the buyer to issue tax-exempt bonds, the transaction must be a loan for federal tax purposes. A loan for federal tax purposes is required because federal regulations do not permit the issuance of tax-exempt bonds for intangible property purchased by municipalities on behalf of corporations. Municipalities or municipal entities created for the benefit of municipalities are, however, under certain circumstances, permitted to issue bonds for intangible property (such as delinquent taxes). The corporation must therefore be considered a controlled entity of the municipality under existing tax regulations. Third, the program must be a sale for state law purposes. Municipalities are not permitted to loan their credit to other entities. Therefore, the sale must be structured in a manner that separates the credit of the corporation (buyer) from that of the municipality (seller). Finally, the municipality must be permitted to sell delinquencies in bulk in order to ensure the continued sale of delinquencies. The ability of the program to issue tax exempt bonds may be determined by the buyer's tax counsel. It is possible that less than 100% of program bonds issued may qualify for tax exemption. It is also possible that the corporation may acquire the municipality's obligation to repay DTANs to qualify for tax exemption. In any event, tax exemption does not impact its value or marketability.

The program is designed to provide AAA rating security for all bonds issued. The AAA rating reduces interest cost on the program debt to the lowest rate possible and, therefore, generates a higher present value. The present value is the projected stream of collections discounted at a market rate which reflects the rating on the program debt. A higher rating corresponds to a lower interest cost and a higher purchase price. At the same time, the higher rating requires a higher level of projected asset coverage. In order to generate higher asset coverage, a lower purchase price percent must be paid.

The program of the present invention assumes that all program bonds are issued as one-year floating interest rate securities. The one-year rate is similar to that of a municipality's DTAN borrowing rates. However, the program has the ability lock in a fixed rate for a longer or shorter period. Although it is assumed the program will carry a one-year rate, the program is a long-term program and interest rates will likely fluctuate over time. The municipality may, therefore, wish to consider a floating rate structure of less than one year. A floating rate of less than one year, whether interest rates increase or decrease is very likely to carry a lower rate than a one-year floating rate over the life of the program due to the nature of the normal upward sloping yield curve.

The interest on all of the outstanding program bonds will have an equal first claim on collections. After the interest is paid, the bond principal is amortized in chronological order payable from the cash flow of purchased tax liens. The first series of bonds will be fully paid in about two years from issuance due to the amortization of the first issue from the cash flow generated by later purchases. Subsequent series are repaid as the cash flow from future tax lien sales is realized. As time progresses, the average life of the debt declines. In the event both taxable and tax exempt bonds are issued or acquired simultaneously, the taxable bonds would preferably be amortized first to reduce the higher cost of the taxable bonds.

In one alternative embodiment, the program utilizes an alternative amortization structure. It may be cost effective to delay amortization of program bonds for some period. Revenue may be used to purchase newly created liens before being used to retire outstanding bonds. The alternate amortization requires that additional program bonds be remarketed annually. This increases the cost of remarketing but reduces the principal amount of new bonds being issued. This approach may also have an impact on the amount of tax exempt bonds permitted to be issued under the program.

The term of the purchase contract has a direct impact on the purchase price, rating, and the interest rate on the program debt as compared to other bulk lien sales. The longer the term of the purchase contract, the higher the purchase price. For a term of forty years, for example, the program is expected to pay about 95% of the present value of the liens purchased during the first twenty years of the program. This is an initial premium of about 25% over the conventional bulk tax lien purchase programs. The 5% coverage from each purchase generates significant asset coverage over time. As asset coverage builds, the average life of subsequent issues is reduced. In many cases, no bonds will be issued toward the end of the program.

The purchase price of the delinquent assets is slightly below the present value of the delinquent assets determined by the formula. For example, the purchase price may be 95% of the present value. The difference between the present value and the purchase price is a surplus over time that provides the security required to make the program financially stable. The program will also provide the seller with an option to terminate future sales after meeting certain criteria. Termination will, most likely, permit the seller to enter into a revised purchase contract with the corporation at a purchase price percent of 100%. Any conversion to 100% will require approval from bankruptcy counsel and the seller's accountant to insure compliance with true sale constraints.

Numerous factors affect the initial purchase price percent required to obtain AAA ratings. Municipalities that have consistent annual delinquencies and consistent collection percentages have more consistent future collections, which increases the initial purchase price percent. There are, however, two factors that the municipality has direct control over that affect the purchase price percent: (1) the bond rating on program debt and (2) the term of the purchase contract.

With regards to the bond rating, the municipality can select the bond rating under which they desire to implement the program. The higher the bond rating: (a) the higher the required projected asset coverage requirement, (b) the lower the borrowing cost, (c) the lower the purchase price percent, and (d) the higher the residual income at the end of the program.

With regards to the terms of the purchase contract, the longer the purchase contract at the initial purchase price percent, the higher the projected asset coverage and the higher the purchase price percent. The purchase price percent for a shorter program is less than the purchase price of a longer program in order to obtain a AAA rating. In order to illustrate the impact of a shorter program, the following illustrates roughly the purchase price percent to obtain a AAA rating. Note, however, that many variables may impact the final rating criteria. In one example, if the term of a program is one year, the purchase price percent is about 60%. If the term of the program is two years, the purchase price percent is about 70%. If the term of the program is three years, the purchase price percent is about 77%. If the term of the program is five years, the purchase price percent is about 85%. If the term of the program is ten years, the purchase price percent is about 90%. If the term of the program is fifteen years, the purchase price percent is about 93%. If the term of the program is twenty years, the purchase price percent is about 95%.

To the extent the municipality is willing to issue debt with a rating below AAA, the initial purchase price may be increased and/or the term of the purchase contract may be reduced.

The bond market also has an impact on the purchase price. In order to obtain a true sale opinion, which is required to generate revenue, the present value of future purchases based on the actual interest and investment rates on the transaction cannot be computed. Instead, an independent market index must be developed. It is reasonable that such an index will vary from the actual borrowing and investment rates by some percent. The program allows the user to enter the expected ranges between the actual borrowing and investment rates and the market borrowing and investment index rates.

In a preferred embodiment of the present invention, the municipality does not reduce interest and penalty rates for delinquent assets during the term of the program. Any change would require a corresponding change in the formula that would impact the purchase price paid for future delinquent assets and would likely require the approval of bankruptcy counsel and an accountant.

A higher credit rating not only requires greater projected asset coverage, but also generates a greater residual at the end of the program. All residuals are used for the benefit of the municipality upon completion or termination of the program.

In the formula, delinquent assets may be purchased yearly or more frequently. On each purchase date, the formula takes into consideration variables related to (a) historical collection data; (b) delinquent assets purchased; (c) market conditions related to borrowing cost and investment rates in existence at the time of each purchase; (d) the purchase price percent; (e) a reasonable time period wherein all remaining delinquent assets are rendered uncollectible; and (f) fees related to the purchase. These variables are explained in further detail below.

With regard to historical collection data during the respective collection period, variables include: (1) historical total principal collected for previously created delinquent assets; (2) historical monthly (or other agreed upon interval) collection amounts of principal for previously created delinquent assets; (3) historical monthly (or other agreed upon interval) collection amounts of interest on previously created delinquent assets; (4) historical monthly (or other agreed upon interval) collection amounts of penalties on previously created delinquent assets; and (5) historical monthly (or other agreed upon interval) adjustments due to revised assessments or any other matters of a recurring nature.

With regard to delinquent assets purchased, variables in the formula include: (1) principal amount of the delinquent assets purchased; (2) interest rates accruing on the delinquent assets purchased; and (3) penalty charges on the delinquent assets purchased.

With regard to market conditions in existence at the time of each purchase, variables in the formula include: (1) the interest rate of the “market borrowing index” related to the bonds being issued at the time of purchase; and (2) the interest rate of the “market investment index” related to the investment rate of delinquent assets to be invested when received.

With regard to the purchase price percent, variables in the formula include: the percentage of the present value at which each series of delinquent assets is to be purchased, wherein the purchase price for this analysis equals 95% of present value. Although the analysis maintains the 95% purchase price over the life of the analysis, after asset coverage exceeds the amount required in the offering documents, the municipality may desire to terminate the program and renegotiate the purchase price with the buyer to a higher percentage of the present value of the liens as determined by the formula.

With regard to the reasonable time period wherein all remaining delinquent assets are rendered uncollectible, variables include: (1) if the program is purchasing delinquent taxes, the asset base (real property) securing the delinquency may permit, for example, a five to seven year collection before a determination is make that the delinquency is uncollectible; (2) if the program is purchasing delinquent credit card receivables, a period less than 5-years may be reasonable due to the fact that the point in time that assets are determined to be collectable is shorter and the collateral backing the collection is of lesser credit quality; and (3) the determination of the specific time period is based on historical collection data.

With regard to expenses related to the purchase, variables include: (1) the program preferably includes the involvement of a number of professionals including accountants, attorneys, financial advisors, underwriters, trustees, and rating agencies; (2) certain of these fees may be paid directly from the proceeds of sale before payment is made to the seller. Alternatively, the seller may pay fees from the proceeds of sale or from other available funds. The buyer may also pay certain fees from the collection of delinquent assets.

The purchase contract may permit the municipality to terminate the program at any time. In the event the municipality terminates the program in the early years, a termination payment may be required. The termination payment is reduced as asset coverage builds up. After a predetermined time has elapsed in the program, no termination payment is required upon termination. This predetermined time is determined with the assistance of the rating agencies.

After the purchase contract term is complete, the municipality may be permitted to (a) cancel the purchase contract and renegotiate a higher purchase price percent with the corporation, (b) cancel the purchase contract without payment, (c) cancel the purchase and enter into a new contract with some other entity, or (d) cancel the purchase contract and end the sale of tax liens.

In the application of the program, a user enters the variables to structure the program for a particular issuer. Liens in any magnitude and range may be entered. Interest rate ranges for borrowing and investment are also entered, as are total estimated principal collection percentages. Actual historical collections eventually replace all of the estimated data when such data is available for an actual entity. The variables are used to give a good proxy for a variety of municipal issuers.

Attached hereto as Appendices A through C are documents illustrating an example of an embodiment of the invention in practice. It will be understood that this embodiment is not limiting in any manner, but is provided for purposes of example only. Appendix A is a report detailing the operation of the invention as embodied in a delinquent tax and asset bond program as proposed to Suffolk County, NY. Appendix B is a presentation comparing lien revenue and cash flow under a previous program to those of a program in accordance with the invention. The presentation also outlines the benefits of the invention compared to other bulk lien sale programs, summarizes the reasons to implement the invention, and lists the major assumptions used in the analysis. The presentation further includes a flowchart showing the flow of funds under a program of the invention, timeline comparisons of a county's existing program with a program according to the invention for the first two years, summary results of the program, line and bar charts comparing the existing program with the program of the invention over its life, and other charts and tables demonstrating the results of the program.

Exhibit C is a spreadsheet showing an example of an actual program in accordance with an embodiment of the invention. In order to show the results of the program it is necessary to enter “Formula Variables” that reflect historical collection data into the worksheets entitled “A-Annual Assumptions” and “B-Initial Purchase Assumptions”. This will provide the entity with an estimate of the results of the program based on their specific collection history. If the entity wishes to implement the program, we enter “Actual Historical Collections” into the Program. The Actual Historical Collections replace the estimates. The Actual Historical Collections, the terms of the Purchase Contract, and the bond market conditions at the time of each sale will determine the Purchase Price paid for the delinquent assets purchased. Following is a summary of the worksheets included in Exhibit C:

Charts

Chart 3A&3B and Charts 4 through 13 are the basis for the charts used in the PowerPoint presentation. It should be noted that data from Chart 3A&3B is first used by Microsoft Visio to provide the data for PowerPoint Charts 3A and 3B.

Graphs

All the Graphs (1 through 9) provide the data used in the above Charts.

Chart Tables

Chart Tables 1 through 4 are used as described above in the PowerPoint presentation.

Tables

Tables 1 through 9 and Table 9-10 are used to provide the information which is included in the Section 3 of the Report described above.

Data Input Worksheets

Worksheet “A-Annual Assumptions” is used to enter the data which is then used by the DTAB Program to generate the analysis.

Worksheet “B-Initial Purchase Assumptions” uses the information provided in “A-Annual Assumptions” together with additional data that may impact the initial purchase.

When actual data is available it is entered into “DATA INPUT-Interest+Penalty” and “DATA INPUT-PRINCIPAL”. The worksheets for “Actual Historical Data” are provided at the end of the excel file to allow someone reviewing the Program to follow the assumption entries more easily. When actual historical data is available, the Program will replace the assumptions with actual data to determine the Program results.

Data Analysis Worksheets

All the following worksheets use the data entered in the Data Input Worksheets to compute Program results:

### SUMMARY

C-Annual Summary: Provides on an annual basis the projected revenue, the actual revenue, the market interest rates, the actual interest rates, and the purchase price of the assets in dollars and as a percent over the life of the Program.

Actual Historical and Future Monthly Collections from Annually Created Tax Liens
Mth P Collected: Actual Monthly Principal Collected
Mth P as % P Created: Actual Monthly Principal Collected as percent of Principal Created
Mth P as % P Collected: Actual Monthly Principal Collected as percent of Total Collected
Mth I Collected: Actual Monthly Interest (+Penalty) Collected
Mth I as % P Created: Actual Interest (+Penalty) Collected as percent of Principal Created
Mth I as % Total P Collected: Actual Interest (+Penalty) Collected as percent of Principal Collected
Avg Mth I Rate: Actual Monthly Interest (+Penalty) Collected monthly as a percent of Actual Principal Collected monthly
Mth P+I Collected: Actual Principal and Interest (+Penalty) Collected Monthly and Annually for each years creations and total collected each month for each fiscal year
Mth P+I as % Total Created: Actual percent of Principal and Interest (+Penalty) Collected Monthly and Annually for each years creations
Mth P+I as % Total Prin Col: Actual percent of Principal and Interest (+Penalty) Collected Monthly and Annually of Total Principal Collected

Projected Future Monthly Collections from Annually Created Tax Liens
Proj Mth P: Projected Monthly Principal Collected
Proj Mth I: Projected Monthly Interest (+Penalty) Collected
Proj Mth P+I: Projected Monthly Total Collected

Revenue and Cash Flow from Existing Tax Lien Collection Process
Existing Revenue: Actual Monthly and Quarterly Revenue under Existing Collection Process for Each Fiscal Year
Support for 14: Actual Total Monthly Collections for each year of Lien creations
Existing 2006 Revenue: Actual Total Revenue for 2006 excluding all other Lien Creations
Existing Cash Flow (DTAN): Actual Total Annual Cash Flow from Existing DTAN Program
Existing 06 Cash Flow (DTAN): Actual Total 2006 Cash Flow from Existing DTAN Program excluding all other Lien Creations

Revenue and Cash Flow Under Delinquent Tax and Asset Bond (DTAB) Program
DTAB Revenue & Cash Flow: Actual Quarterly DTAB Revenue and Amortization of Program Bonds
DTAB 06 Revenue & Cash Flow: DTAB Revenue and Amortization of Program Bonds using only 2006 Lien Creations
DTAB Annual Lien Col: Monthly Revenue and Investment Earnings used to Determine funds Available to Amortize DTAB Program Debt in worksheet #19
DTAB 06 Annual Lien Col: Monthly Revenue and Investment Earnings used to Determine funds Available to Amortize DTAB Program Debt using only 2006 Lien Creations
DTAB Initial Rev Support: Determination of Initial Purchase based on Issue Date of Initial Issue Initial Yr Rev Allocation: Monthly Revenue (including Investment Earnings) Allocated to the Seller or the Buyer depending on the Date of the Initial Sale

Factors and Percentages Used to Create Projected Historical and Future Collections
Proj Mthly % P: Projected Principal Collected as % of Amount Created. Percentage equals the (Average Principal Collected/Average Principal Created) as a % for each Month of the Total Prescribed Historical Collection Period.
Proj Mth I as % of P: Projected Interest (+Penalty) Collected as % of Amount Created. Percentage equals the (Average Interest (+Penalty) Collected/Average Principal Created) as a % for each Month of the Total Prescribed Historical Collection Period.
Proj Mth % Pr+I: Equals Total of two Previous Tables.
Proj-Mth I as % of Mth Pr Col: Projected Monthly Percent of Interest (+Penalty) Collected as a Percent of Monthly Principal Collected. %. Equals (Average Interest (+Penalty) Collected/Average Principal Collected) as a % for each Month of the Total Prescribed Historical Collection Period. This Percentage should remain constant, unless, when Actual Historical Numbers are used there are different percentages applicable to different types of delinquent assets, or outside adjustments applied to Interest Charges.
Proj Tot “Avg” P Col: The Average Principal Collected equals the Total Actual Principal Collected over the Prescribed Historical Collection Period divided by the Number of Years in Such Period.

Actual Monthly Collections from Tax Liens Outstanding at Time of Initial Purchase
30. Initial P Mth: Total Monthly Collections of Actual Initial Principal Starting with each Month of the Initial Fiscal Year in which the DTAB Program is implemented.
Initial I Mth: Total Monthly Collections of Actual Initial Interest (+Penalty) starting with each Month of the Initial Fiscal Year in which the DTAB Program is implemented.
Initial Pr+I Mthly: Total of Previous Two Tables.

Projected Monthly Collections from Tax Liens Outstanding at Time of Initial Purchase
Proj. Initial Pr+I: Initial Projected Principal and Interest (+Penalty) Collected Monthly during Initial Fiscal Year DTAB Program is Implemented. (Used for worksheet #34)
Col for Purchase Price: Total Outstanding Projected Principal and Interest (+Penalty) Collected over Life of Program (Used as Part of formula for (worksheet #36) Determining Annual Purchase Price)
Initial Purchase Price: Purchase Price Calculation for Initial Purchase of Outstanding Liens as of the Initial Purchase Date.
Purchase Price for Annual: Purchase Price Calculation for Annual Lien Purchases as of the Respective Purchase Date over the Life of the DTAB Program.

Projected Assets for Coverage
Proj Assets for Coverage: Calculation of Projected Outstanding Liens Purchased by the DTAB Program.
Proj PV Assets for Coverage: Calculation of the present value of the Projected Outstanding Liens Purchased by the DTAB Program. These Assets are Included in Computing the Asset Coverage Ratio

Results of Random Number Generator

(Historic Numbers will be Replaced Automatically by Program when they are Entered into Program)

Random Mth % P: Principal Collected Monthly over life of each Lien based on random collection cycle.
Random Mth I as % of P: Interest (+Penalty) collected monthly as percent of Principal (determined in worksheet #39) and Interest (+Penalty) from worksheet #45.
Random Total % P+I: Total of previous two tables.
Random Ratio Factors-P Col: Calculation of monthly numbers generated by random number generator.
Min and Max Percent Calc: Determination of the minimum and maximum monthly Principal collection amounts based on the entered minimum and maximum collection factors.
Random 100% Ratio Factors: Calculation of the maximum monthly Principal collection percentages based on the numbers computed by worksheet #42.
DATA INPUT Mth I Rate: In order to provide historical Interest (+Penalty) to the Program, interest rate from worksheet A-Annual Assumptions are entered here and used in the next worksheet. If Actual Historical Interest (+Penalty) is available this worksheet is not required.
DATA INPUT-INTEREST: This is the Actual Historical Interest (+Penalty) used in the analysis, when it is available. When set to “0” the Program generates amounts for the analysis.
DATA INPUT-PRINCIPAL: This is the Actual Historical Principal used in the analysis, when it is available. When set to “0” the Program generates amounts for the analysis.
Support-Assumptions: A summary of the minimum and maximum Principal and Interest (+Penalty) Collections on an annual basis, based on the assumptions entered into the Program.
Support-Interest Rates: This is the Actual monthly Interest (+Penalty) collected. For analysis purposes it may equal to the maximum rate established or be permitted to float based on the assumption that adjustments may be required near the end of the collection period.

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they fall within the spirit and the scope of the invention as described herein.

1. A method for providing revenue from a dynamic portfolio of delinquent assets, the method comprising:
agreeing to sell a plurality of delinquent assets in a dynamic portfolio of delinquent assets on a periodic basis during an agreement term;
for an agreement period:
obtaining historical data reflecting a first portfolio of delinquent assets;
using the historical data to determine a first historical collection model;
determining a first projection of collections for a set of delinquent assets based upon the first historical collection model;
calculating a first present value of the first projection of collections;
determining a first delinquent asset purchase price for the set of delinquent assets, wherein the first delinquent asset purchase price is less than or equal to the first present value;
selling the set of delinquent assets for the first delinquent asset purchase price, thereby providing revenue from the dynamic portfolio of delinquent assets; and,
for a subsequent agreement period:
obtaining subsequent historical data reflecting a subsequent portfolio of delinquent assets;
using the subsequent historical data to determine a subsequent historical collection model;
determining a subsequent projection of collections for a subsequent set of delinquent assets based upon the subsequent historical collection model;
calculating a subsequent present value of the subsequent projection of collections;
determining a subsequent delinquent asset purchase price for the subsequent set of delinquent assets, wherein the subsequent delinquent asset purchase price is less than or equal to the subsequent present value; and,
selling the subsequent set of delinquent assets for the subsequent delinquent asset purchase price, thereby providing additional revenue from the dynamic portfolio of delinquent assets.

2. The method of claim 1, wherein the first present value is based upon a market borrowing index and a market investment index.

3. The method of claim 2, wherein the first delinquent asset purchase price is less than the first present value.

4. The method of claim 1, wherein the subsequent delinquent asset purchase price is less than the subsequent present value.

5. The method of claim 1, further comprising:
issuing at least one bond;
using proceeds from said at least one bond to pay at least a portion of the first delinquent asset purchase price.

6. The method of claim 5, wherein the at least one bond comprises at least one of: a tax-exempt bond and a taxable bond.

7. The method of claim 5, wherein the at least one bond comprises a combination of both a tax-exempt bond and a taxable bond.

8. The method of claim 1, wherein the first projection of collections for a set of delinquent assets includes principle, along with interest and penalties due as a result of the delinquency of set of delinquent assets.

9. The method of claim 1, wherein the steps of obtaining subsequent historical data, using the subsequent historical data to determine a subsequent historical collection model, determining a subsequent projection of collections, calculating a subsequent present value of the subsequent projection of collections, determining a subsequent delinquent asset purchase price, and selling the subsequent set of delinquent assets for the subsequent delinquent asset purchase price, are performed at least once per period throughout a term of the agreement.

10. The method of claim 1, wherein the step of agreeing to sell a plurality of delinquent assets in a dynamic portfolio of delinquent assets on a periodic basis comprises agreeing to periodically calculate a current present value of the a current projection of collections and to periodically sell the plurality of delinquent assets at a current delinquent asset purchase price which is less than or equal to the current present value.

11. The method of claim 1, wherein the agreement period is a first period during which the agreement is in place.

12. The method of claim 1, wherein the agreement period is a period other than the first period during which the agreement is in place.

13. The method of claim 1, wherein the subsequent agreement period is a period immediately following the agreement period.

14. The method of claim 1, wherein the subsequent agreement period is a period other than a period immediately following the agreement period.

15. The method of claim 1, further comprising:
paying transactional fees incurred in connection with the sale of the set of delinquent assets before payment is made to a seller of the delinquent assets.

16. The method of claim 15, further comprising:
paying transactional fees directly from the proceeds of the sale of the set of delinquent assets.

17. The method of claim 15, wherein the transactional fees comprise fees of at least one service provider selected from the set of:
accountants, attorneys, financial advisors, underwriters, trustees, and rating agencies.

18. The method of claim 1, further comprising:
transferring revenue derived from the sale of the set of delinquent assets from a buyer to a stabilization fund.

19. The method of claim 18, further comprising:
using the stabilization fund for the payment of debt service on bonds which have been issued to pay the first delinquent asset purchase price.

20. The method of claim 19, further comprising:
using the stabilization fund to fund at least a portion of the purchase of newly created delinquent assets.

21. The method of claim 19, further comprising:
using the stabilization fund to fund at least a portion of the purchase newly created delinquent assets when all outstanding bonds have been redeemed.

22. The method of claim 20, further comprising:
using residual stabilization funds for the benefit of a municipality's residents after all program bonds are retired and the program's final tax liens are purchased.

23. The method of claim 1, wherein the step of selling the set of delinquent assets for the first delinquent asset purchase price is performed by a municipality.

24. The method of claim 22, wherein the step of selling the set of delinquent assets for the first delinquent asset purchase price further comprises selling the set of delinquent assets to a legal entity that meets the requirement of providing a true sale of the set of delinquent assets under GAAP.

25. The method of claim 22, wherein the step of selling the set of delinquent assets for the first delinquent asset purchase price further comprises selling the set of delinquent assets to a local development corporation.

26. The method of claim 22, wherein the step of selling the set of delinquent assets for the first delinquent asset purchase price further comprises selling the set of delinquent assets to a corporation created or expanded to purchase delinquent assets.

27. The method of claim 22, wherein the step of selling the set of delinquent assets for the first delinquent asset purchase price further comprises selling the set of delinquent assets to a trust.

28. A method for providing revenue from delinquent assets, the method comprising the steps of:
selecting a period for buying a plurality of delinquent assets;
determining a payment price for the plurality of delinquent assets at selected intervals of the period;
determining a historical collection cycle;
estimating delinquent assets to be collected during the selected interval based on a most recent completed historical collection cycle;
making an initial payment for delinquent assets, wherein the initial payment comprises outstanding delinquent assets and estimated delinquent assets to be collected;
making at least one interval payment, wherein the payment is made at the selected intervals and comprises the estimated delinquent assets to be collected;
wherein payments are made until the selected interval that occurs at the period length minus the length of the collection cycle; and
issuing or acquiring bonds, wherein proceeds are used to purchase delinquent assets.

29. The method of claim 28 wherein the initial payment is not more than a present value of the delinquent assets, the present value being calculated based upon a market borrowing index and a market investment index.

30. A method for a municipality to generate revenue and cash from tax liens, the method comprising:
agreeing to sell a plurality of delinquent assets in a dynamic portfolio of delinquent assets to a local development corporation on a periodic basis during an agreement term;
for each of a plurality of periodic dates during the agreement term:
obtaining historical data reflecting a portfolio of delinquent assets existing prior to the periodic date;
using the historical data to determine a historical collection model for assets delinquent on the periodic date;
determining a projection of collections for a set of assets delinquent on the periodic date based upon the historical collection model;
calculating a present value of the projection of collections;
determining a delinquent asset purchase price for the set of delinquent assets, wherein the delinquent asset purchase price is less than or equal to the present value of the set of delinquent assets as determined by the market borrowing index and market investment index; and,
selling the set of delinquent assets to a local development corporation for the delinquent asset purchase price, thereby providing revenue from the dynamic portfolio of delinquent assets;
reassigning proceeds derived from the sale of the set of delinquent assets to the local development corporation;
using the reassigned proceeds to recoup the delinquent asset purchase price; and
allocating the remaining reassigned proceeds to a stabilization fund.

31. The method of claim 30 further comprising using the stabilization fund to fund at least a portion of the purchase of delinquent assets on a periodic date, and using the stabilization funds for the benefit of the municipality's residents after agreement term.

32. The method of claim 30 further comprising using the reassigned proceeds to pay transactional fees associated with the agreement before allocating the remaining reassigned proceeds to a stabilization fund;

33. The method of claim 30 further comprising:
issuing at least one bond;
using bond proceeds from said at least one bond to fund the purchase of delinquent assets on a periodic date; and
wherein the step of using the reassigned proceeds comprises recouping the delinquent asset purchase price by retiring the at least one bond.
